(19) United States
(12) Patent Application Publication
(10) Pub. No.: US 2012/0191480 A1
(43) Pub. Date: Jul. 26, 2012

(54) HEALTH MANAGEMENT PLATFORM AND METHODS

(75) Inventors: Amit Gupta, Cortlandt, NY (US); Narinder Makin, Hamden, CT (US)

(73) Assignee: HEALTHPER, INC., Princeton, NJ (US)

(21) Appl. No.: 13/438,528

(22) Filed: Apr. 3, 2012

Related U.S. Application Data
(63) Continuation of application No. 13/004,503, filed on Jan. 11, 2011.

(51) Int. Cl. G06Q 50/24

(52) U.S. Cl. 705/3

(57) ABSTRACT

A computer-implemented interactive social networking based system and methods allowing efficient health management. In an illustrative implementation, a computing environment comprises a healthcare portfolio management engine (HPME) having at least one instruction providing for the creation of one or more healthcare programs comprising one or more incentives that can be achieved by completing one or more healthcare promoting activities. In an illustrative implementation, the HPME can also comprise healthcare portfolio guidelines that provide threshold requirements including community feedback to assist participating users in managing the user's health. Further, the HPME allows for the sharing of a user's health data according to a selected community-based health promoting model. In an illustrative operation, participating users, community members, incentive sponsors, and/or healthcare collaborators can interact with the computing environment to share data representative of program support, incentives, services, and/or products to assist the user in achieving better health.

### CROSS REFERENCE TO RELATED APPLICATIONS

This application is a continuation of U.S. patent application Ser. No. 13/004,503 filed on Jan. 11, 2011.

### BACKGROUND

Healthcare management and health management have become increasingly important with elevating costs associated with healthcare that can be attributed to an increasing incidence of chronic conditions, poor lifestyle choices, and overall unhealthy behaviors/attitudes which are generally being unattended by those who are afflicted. More and more, the general population is being charged with taking ownership of their own healthcare, often inundated with substantial amounts of information regarding health management and healthcare plans. These healthcare plans, to which a person may be eligible, can be used in identifying unhealthy practices and, more importantly, can be applied to promote better health or, more generally, for overall health management. However, such information is often complicated to organize/digest and is discrete such that it might be delivered to a person only once devoid of a mechanism to allow follow up with a person to determine if such information has been properly digested and, more importantly, if such digested information has contributed positively to the person's health management.

Specifically, the vast majority (e.g., over 80%) of health care costs can be attributed to individuals failing to take proactive measures to maintain their health. Individuals treat health care and health insurance as an enabler of an unhealthy lifestyle - the rewards for living healthily are minimal while personal cost and effort can be very high; but unhealthy lifestyles are easy and often cheap, yet bear little extra cost when it comes to health care. Often is the case that insurers and employers foot the bill for individuals' unhealthy lifestyles.

Current practices attempt to promote individual ownership of health management. Specifically, a current practice allows for insurance companies and employers to incentivize individuals to lead healthier lifestyles, but incentives are short lived and have little long term value to the individuals. Accordingly, studies suggest that participation in such incentive programs is relatively low—i.e., 20-30%. Such practice is lacking since it does not address the reality of how individuals perceive and interact with their personal health and health care, and fails to provide adequate incentives to encourage the necessary behavioral change.

Additional shortcomings of existing practices can be categorized to a number of areas which are problematic in current health engagement strategies. Specifically, current practices are deficient in providing effective social support communication tools that would allow a person to efficiently leverage their own social influencers (e.g., family, friends, co-workers, teammates, etc.). Additionally, although some current practices allow for the redemption of an incentive based on achieving a specific health management goal, these practices as a standalone practice are not effective in promoting effective/efficient health management and/or engaging people to manage their health.

Furthermore, current practices significantly lack in providing efficient, readily available communication tools that allow for monitoring and promotion of various programs customizable and robust to optimize an individual's health and to effectuate efficient health management. Such communication between an individual, the individual's support network, the individual's healthcare providers, and/or third party healthcare service providers is tantamount to successful health management. Specifically, communicating feedback and/or establishing/communicating incentive(s) to an individual regarding progress relating to a program (i.e., achieving a program threshold) designed/communicated to the individual directly impacts the ability of the individual to properly maintain and manage their health. It has been proven that the biggest motivator for people in managing their health is a need for autonomy, to self direct, and self manage their health management and healthcare resources.

However, current solutions do not satiate this need since they do not provide an integrated data environment that allows for the creation of specific programs having attached incentives (i.e., sponsored or unsponsored incentives) for an individual that are communicated by the environment to the individual and among the individual's social network/influencers ((e.g., family, friends, co-workers, teammates, etc.), healthcare providers, and third party healthcare services providers that also provides monitoring and feedback to the individual regarding their adherence to one or more of the created programs.

Furthermore, current solutions do not calculate a health rating having a health score that shows the overall state of an individual's health based various data inputs (e.g., individual's health history, individual's progress in one or more programs, etc.) as well as do not communicate the health rating in the context of a health report that communicates to an individual not only their health score but also their progress in adhering to one or more healthcare programs (e.g., number and type of health medals and health awards). Current solutions do not provide health ratings and/or health scores which do not allow participating users to stay motivated to maintain and manage health. Furthermore, with current practices, participating users are not afforded a marketplace in which they can purchase reduced health benefits based on increasing health scores.

From the foregoing, it is appreciated that there exists a need for systems and methods that are aimed to ameliorate the shortcomings of existing practices.

### SUMMARY

A computer-implemented interactive social networking based system and methods allowing health management that promotes improved healthcare are provided. In an illustrative implementation, a computing environment comprises a healthcare portfolio management engine (HPME) (e.g., health management platform) having at least one instruction providing for the creation of one or more healthcare programs comprising one or more incentives that can be achieved by completing one or more healthcare promoting activities. In an illustrative implementation, the HPME can also comprise healthcare portfolio guidelines that provide threshold requirements including community feedback to assist participating users in managing the user's health.

Furthermore, the HPME allows for the sharing of a user's health data according to a selected community-based health promoting model. In an illustrative implementation, the selected community-based health promoting model comprises one or more instructions to process data representative of one or more recommendations provided by a community of cooperating healthcare providers and/or support personnel (e.g., friends, family, health community forum participants, etc.) for a user for use in health management decisions.

In an illustrative operation, participating users, community members, incentive sponsors, and/or healthcare collaborators can interact with the computing environment to share data representative of one or more program components, support, incentives, services, and/or products to assist a user in managing their health. In the illustrative operation, the HPME can receive data input from one or more users to generate data representative of a healthcare portfolio comprising one or more programs that provide recommendations for health management particular to a user or a group of users.

In another illustrative operation, the HPME receives data representative of compliance with one or more of the programs of the healthcare portfolio. Responsive to the input of compliance data, the HPME compares the received inputted compliance data with one or more predefined compliance thresholds. In the illustrative operation, data representative of one or more health awards is generated by the HPME, the health awards representative of achieving one or more program thresholds. Furthermore, in the illustrative implementation, HPME calculates a health rating comprising health score for a user, the health score calculation being based on data received by the HPME representative of one or more of a user's health, one or more healthcare portfolios, one or more programs, and one or more compliance data.

In an illustrative implementation, the HPME generates data representative of a sponsorship opportunity for one or more incentives. In an illustrative operation the generated sponsorship data is operatively communicated to one or more participating sponsors. In the illustrative operation, participating sponsors communicate data to the HPME representative of a sponsoring one or more of the incentives. The HPME associates that sponsor to the one or more incentive such that the sponsor is directed an invoice by the HPME when an incentive is redeemed by a user.

Other features of the herein described systems and methods are further described below.

### BRIEF DESCRIPTION OF THE DRAWINGS

The interactive systems and methods for social networking based incentive based health management are described with reference to the accompanying drawings in which:

FIG. 1 is a block diagram of an exemplary computing environment in accordance with an implementation of the herein described systems and methods;

FIG. 2 is a block diagram showing the cooperation of exemplary components of an illustrative implementation in accordance with the herein described systems and methods;

FIG. 3 is a block diagram showing the cooperation of exemplary components of another illustrative implementation in accordance with the herein described systems and methods;

FIG. 4 is a block diagram showing an illustrative block representation of an illustrative interactive health management system in accordance with the herein described systems and methods;

FIG. 5 is a block diagram describing the interaction of various components of an exemplary health management platform in accordance with the herein described systems and methods;

FIG. 6 is a block diagram describing an exemplary health management scheme in accordance with the herein described systems and methods;

FIG. 7 is a flow diagram showing illustrative processing performed when performing social networked based/incentive based health management in accordance with the herein described systems and methods.

FIG. 8 is a flow diagram showing illustrative processing when designing one or more programs as part of health management in accordance with the herein described systems and methods;

FIG. 9 is a flow diagram showing illustrative processing when processing one or more incentives as part of health management in accordance with the herein described systems and methods;

FIG. 10 is a flow diagram showing illustrative processing when processing the redemption of one or more achieved incentives in accordance with the herein described systems and methods;

FIG. 11 is a flow diagram showing illustrative processing when generating a health report having a calculated health score in accordance with the herein described systems and methods; and

FIG. 12 is a flow diagram showing illustrative processing when processing sponsored incentives in accordance with the herein described systems and methods.

### DETAILED DESCRIPTION

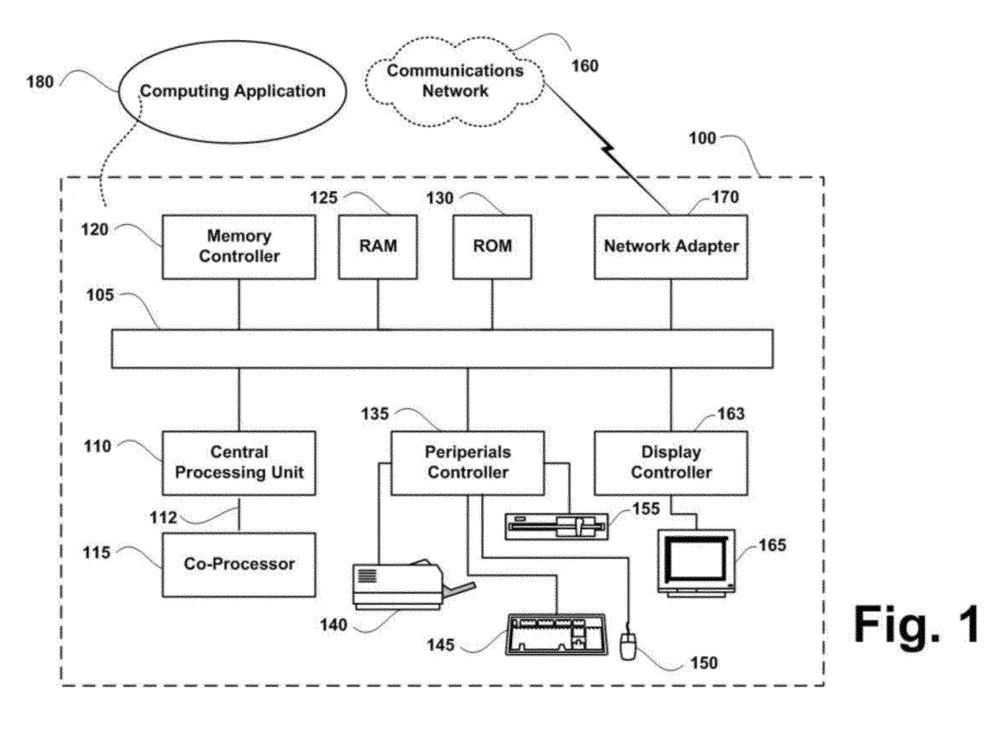

FIG. 1 depicts an exemplary computing system 100 in accordance with herein described system and methods. The computing system 100 is capable of executing a variety of computing applications 180. Computing application 180 can comprise a computing application, a computing applet, a computing program and other instruction set operative on computing system 100 to perform at least one function, operation, and/or procedure. Exemplary computing system 100 is controlled primarily by computer readable instructions, which may be in the form of software. The computer readable instructions can contain instructions for computing system 100 for storing and accessing the computer readable instructions themselves. Such software may be executed within central processing unit (CPU) 110 to cause the computing system 100 to do work. In many known computer servers, workstations and personal computers CPU 110 is implemented by micro-electronic chips CPUs called microprocessors. A coprocessor 115 is an optional processor, distinct from the main CPU 110 that performs additional functions or assists the CPU 110. The CPU 110 may be connected to co-processor 115 through interconnect 112. One common type of coprocessor is the floating-point coprocessor, also called a numeric or math coprocessor, which is designed to perform numeric calculations faster and better than the general-purpose CPU 110.

In operation, the CPU 110 fetches, decodes, and executes instructions, and transfers information to and from other resources via the computer's main data-transfer path, system bus 105. Such a system bus connects the components in the computing system 100 and defines the medium for data exchange. Memory devices coupled to the system bus 105 include random access memory (RAM) 125 and read only memory (ROM) 130. Such memories include circuitry that allows information to be stored and retrieved. The ROMs 130 generally contain stored data that cannot be modified. Data stored in the RAM 125 can be read or changed by CPU 110 or other hardware devices. Access to the RAM 125 and/or ROM 130 may be controlled by memory controller 120. The memory controller 120 may provide an address translation function that translates virtual addresses into physical addresses as instructions are executed.

In addition, the computing system 100 can contain peripherals controller 135 responsible for communicating instructions from the CPU 110 to peripherals, such as, printer 140, keyboard 145, mouse 150, and data storage drive 155. Display 165, which is controlled by a display controller 163, is used to display visual output generated by the computing system 100. Such visual output may include text, graphics, animated graphics, and video. The display controller 163 includes electronic components required to generate a video signal that is sent to display 165. Further, the computing system 100 can contain network adaptor 170 which may be used to connect the computing system 100 to an external communication network 160.

### Illustrative Computer Network Environment:

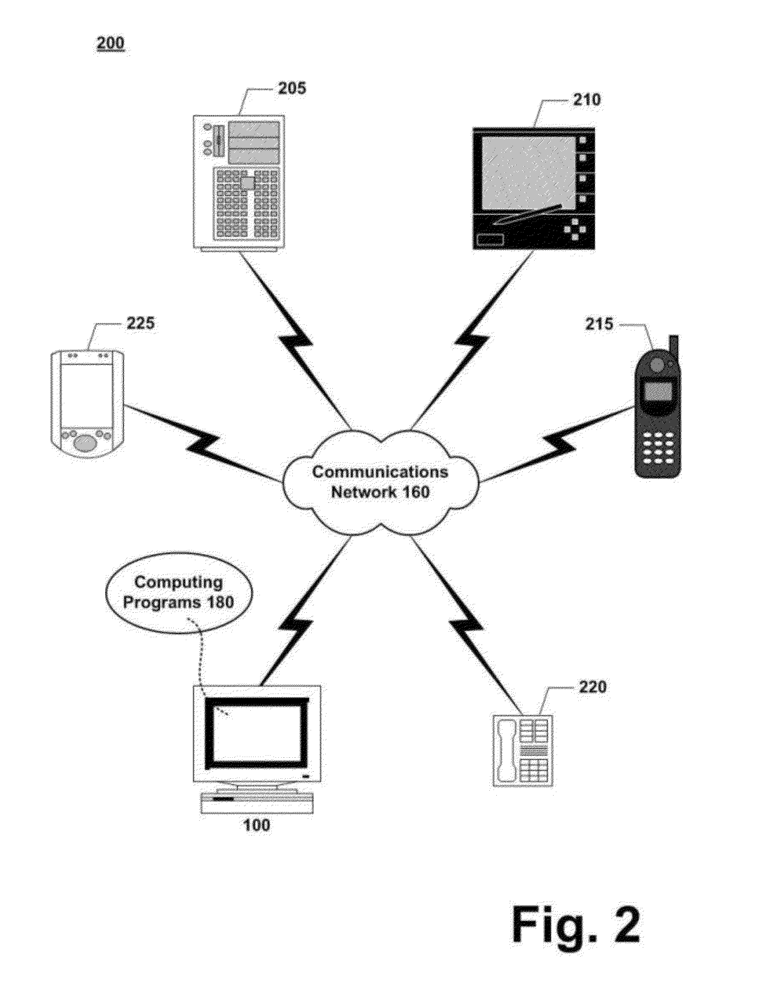

Computing system 100, described above, can be deployed as part of a computer network. In general, the above description for computing environments applies to both server computers and client computers deployed in a network environment. FIG. 2 illustrates an exemplary illustrative networked computing environment 200, with a server in communication with client computers via a communications network, in which the herein described apparatus and methods may be employed. As shown in FIG. 2, server 205 may be interconnected via a communications network 160 (which may be either of, or a combination of a fixed-wire or wireless LAN, WAN, intranet, extranet, peer-to-peer network, virtual private network, the Internet, or other communications network) with a number of client computing environments such as tablet personal computer 210, mobile telephone 215, telephone 220, personal computer 100, and personal digital assistance 225. In a network environment in which the communications network 160 is the Internet, for example, server 205 can be dedicated computing environment servers operable to process and communicate data to and from client computing environments 100, 210, 215, 220, and 225 via any of a number of known protocols, such as, hypertext transfer protocol (HTTP), file transfer protocol (FTP), simple object access protocol (SOAP), or wireless application protocol (WAP). Additionally, networked computing environment 200 can utilize various data security protocols such as secured socket layer (SSL) or pretty good privacy (PGP). Each client computing environment 100, 210, 215, 220, and 225 can be equipped with operating system 180 operable to support one or more computing applications, such as a web browser (not shown), or other graphical user interface (not shown), or a mobile desktop environment (not shown) to gain access to server computing environment 205.

In operation, a user (not shown) may interact with a computing application running on a client computing environments to obtain desired data and/or computing applications. The data and/or computing applications may be stored on server computing environment 205 and communicated to cooperating users through client computing environments 100, 210, 215, 220, and 225, over exemplary communications network 160. A participating user may request access to specific data and applications housed in whole or in part on server computing environment 205. These data may be communicated between client computing environments 100, 210, 215, 220, and 220 and server computing environments for processing and storage. Server computing environment 205 may host computing applications, processes and applets for the generation, authentication, encryption, and communication data and applications and may cooperate with other server computing environments (not shown), third party service providers (not shown), network attached storage (NAS) and storage area networks (SAN) to realize application/data transactions.

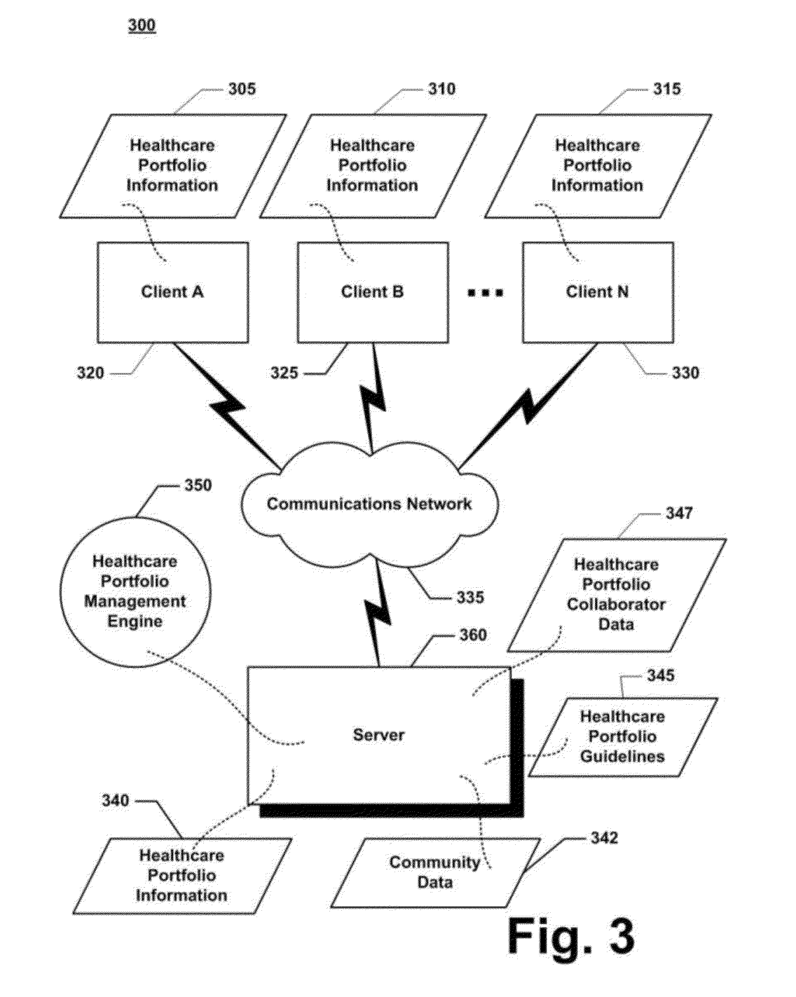

FIG. 3 shows an illustrative implementation of exemplary health management platform 300. As is shown in FIG. 3, exemplary health management platform 300 comprises client computing environment 320, client computing environment 325 up to and including client computing environment 330, communications network 335, server computing environment 360, healthcare portfolio management engine 350, healthcare portfolio information data 340, community data 342, healthcare portfolio guidelines 345, and healthcare portfolio collaborator data 347. Also, as is shown in FIG. 3, health management platform 300 can comprise a plurality of healthcare portfolio information data (e.g., one or more health management data components) 305, 310, and 315 which can be displayed, viewed, stored, electronically transmitted, and printed from client computing environments 320, 325, and 330, respectively.

In an illustrative operation, client computing environments 320, 325, and 330 can communicate and cooperate with server computing environment 360 over communications network 335 to provide requests for and receive healthcare portfolio information data 305, 310, and 315. In the illustrative operation, health portfolio management engine 350 can operate as a web-based computing application on server computing environment 360 to provide one or more instructions to server computing environment 360 to process requests for healthcare portfolio information data 305, 310, and 315 and to electronically communicate healthcare portfolio information data 305, 310, and 315 to the requesting client computing environment (e.g., client computing environment 320, client computing environment 325, or client computing environment 335). As part of processing requests for healthcare portfolio information data 305, 310, and 315, healthcare portfolio management engine 350 can utilize a plurality of data comprising healthcare portfolio information data 340, community data 342, healthcare portfolio guidelines 345, and/or healthcare portfolio collaborator data 347. Also, as is shown in FIG. 3, client computing environments 320, 325, and 330 are capable of processing healthcare portfolio information data 305, 310, and 315 for display and interaction to one or more participating users (not shown).

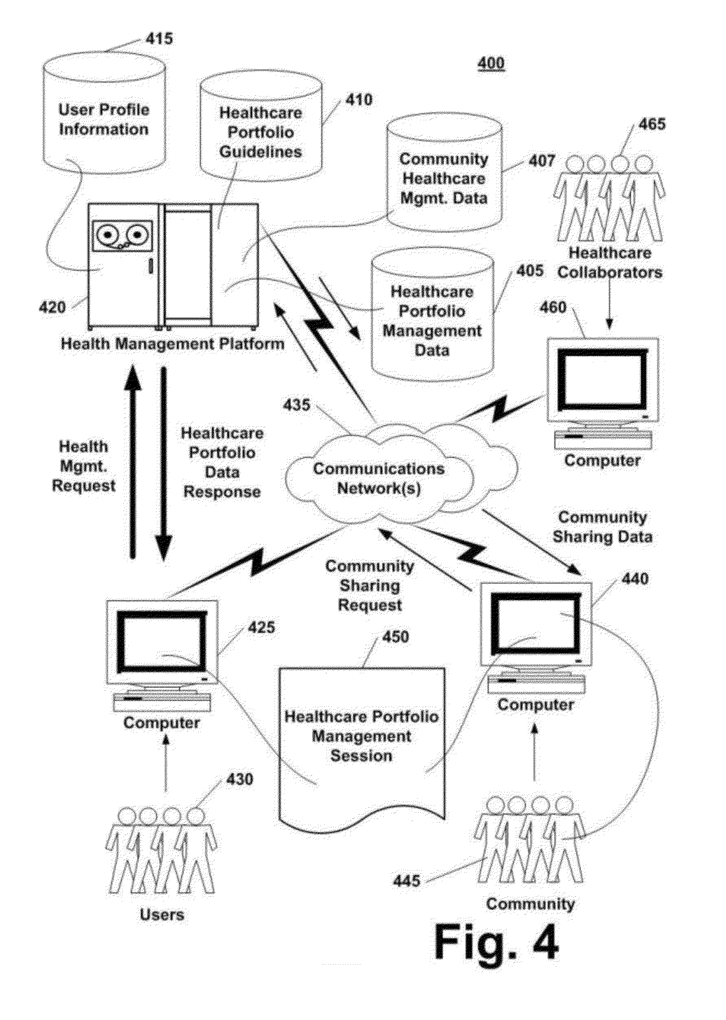

FIG. 4 shows a detailed illustrative implementation of health management environment 400. As is shown in FIG. 4, exemplary health management environment 400 comprises health management platform 420, user profile information data store 415, healthcare portfolio guidelines data store 410, healthcare portfolio management data store 405, and community healthcare management data store 407, user computing environment 425, participating users 430, community computing environment 440, community members 445, healthcare collaborators computing environment 460, and healthcare collaborators 465. Additionally, as is shown in FIG. 4, health management environment 400 can comprise healthcare portfolio management session content (e.g., live and/or stored) 450 which can be displayed, viewed, transmitted and/or printed from user computing environment 425, community computing environment 440, and/or healthcare collaborator computing environment 460.

In an illustrative implementation, health management platform 420 can be electronically coupled to user computing environment 425, community computing environment 440, and healthcare collaborator computing environment 460 via communications network 435. In the illustrative implementation, communications network can comprise fixed-wire and/or wireless intranets, extranets, and the Internet.

In an illustrative implementation, health management platform 420 comprises a web-based computing application operable on one or more web servers (not shown) allowing access to users 430, community members 445, and healthcare collaborators 465 through a web browser (not shown) using the Internet as the shared communications network.

In an illustrative operation, users 430 can interact with health management interface (not shown) operating on user computing environment 425 to provide requests to initiate a healthcare portfolio management session 450 that are passed across communications network 435 to health management platform 420. In the illustrative operation, health management platform 420 can process requests for a healthcare portfolio management session 450 and cooperate with interactive user profile information data store 415, healthcare portfolio guidelines data store 410, healthcare portfolio management data store 405, and community data store 407 to generate a healthcare portfolio management session for use by users 430, community 445, and healthcare collaborators 465.

In an illustrative implementation, interactive user profile information data store 415 can comprise data representative including but not limited to, a user's medical history, a user's demographic data (e.g., location, employment, income, race, age, etc.), a user's preference to share data with one or more community members 445, user incentive data, user incentive redemption data, and/or third party healthcare collaborators 465, a user's employer data, a user's benefit plan data, and other data associated with the health management of the user. In the illustrative implementation, healthcare portfolio guideline data store 410 can comprise data representative of one or more health management program components that can be communicated to the user computing environment 425 and users 430 by health management platform 420 as part of a comprehensive plan to manage the user's health. Healthcare portfolio management data store 405 can comprise data representative of user profile data, user medical history data, one or more program metrics (e.g., health promoting activity thresholds)of one or more program components of one or more programs for a specific one or more user, user incentive data, user incentive redemption data, user health rating data, other associated health management data specific to one or more of users, and other user data relevant for use to provide one or more features/operations by the herein described systems and methods.

In the illustrative implementation, healthcare portfolio guidelines data store 410 can comprise data representative of one or more incentive redemption procedures, one or more program definition, one or more guidelines regarding interdependent programs, ranges for one or more program metrics, data security guidelines, and other associated guidelines for use to provide one or more features/operations by the herein described systems and methods. Community rating data store 407 can comprise data representative of community feedback and interactions between community members 445 and users regarding the health management for one or more users 430 and/or community members 445.

In an illustrative operation, as part of healthcare portfolio management session 450, one or more participating users 430 can interact with exemplary health management platform 420 using user computing environment 425 over communications network 435 to submit data representative of the one or more users' profile for processing and storage by exemplary health management platform 420 in user profile information data store 415. In the illustrative operation, as part of healthcare portfolio management session 450, exemplary health management platform 420 can communicate various health management data (e.g., retrieved from one or more cooperating data stores 405, 407, 410, and 415 and/or received from other cooperating computing environments—healthcare collaborator computing environment 460 and/or community computing environment 440) to one or more participating users 430 over communications network 435 in accordance with the exemplary features/operations described herein.

Exemplary features/operations of exemplary health management environment 400 can comprise: allowing for the design/creation of one or more programs having one or more program components with one or more program metrics that comprise a portion of the user's healthcare portfolio; engagement of one or more participating users to participate in one or more programs (e.g., programs specific to the user based on user profile data, user healthcare portfolio data); tracking of program compliance (e.g., user input and input from third parties who can validate user compliance); delivery of incentive(s) to the one or more participating users based on compliance with one or more program metrics; tracking the redemption of incentives (e.g., communication with one or more third party healthcare collaborators and/or incentive sponsors); making available incentives for sponsorship by one or more interested sponsors; communication/coordination/management of health management discussions/threads, recommendations, support data amongst and betwixt users, community members, and/or third party healthcare collaborators (e.g., a health spa providing recommendations for skin care as it relates to an skin cancer prevention program) based on users' data sharing preferences; and creation and communication of comprehensive health report that incorporates data from the user's health portfolio, user's profile, and user compliance with one or more programs that also includes a health rating/score that is calculated by the exemplary health management platform using the user's healthcare portfolio data and user program compliance data.

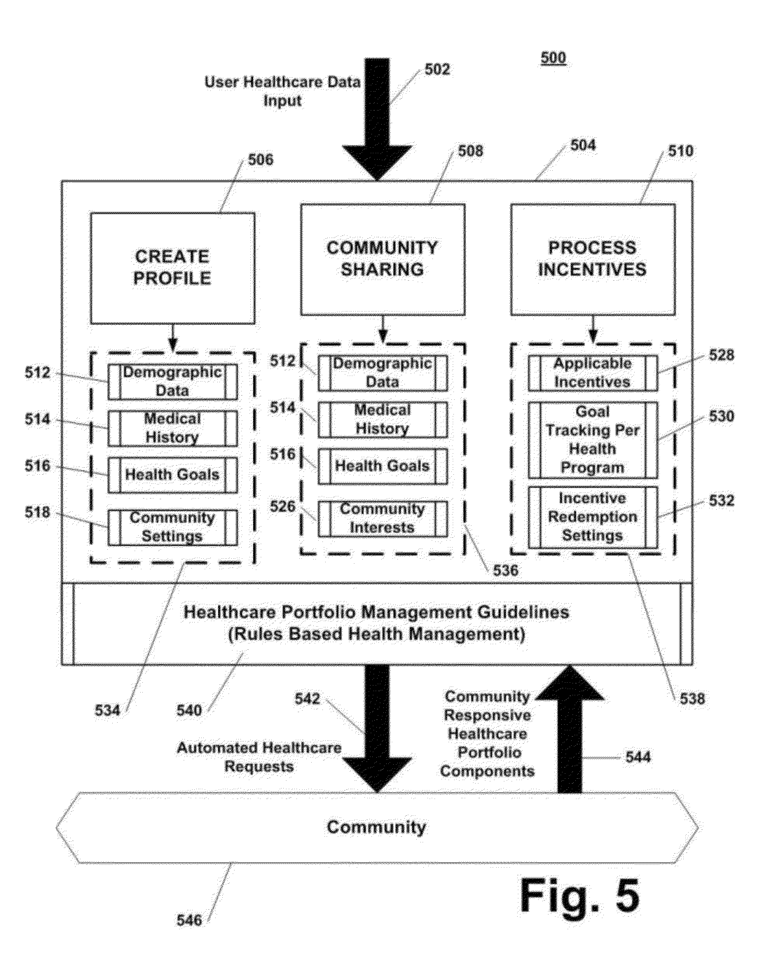

FIG. 5 shows illustrative interaction of various cooperating data and illustrative operations for exemplary health management environment 500. As is shown health management environment 500 comprises user data input 504, health management platform 504, and community 546. Further, as is shown, health management platform 504 comprises healthcare portfolio management guidelines 540, create profile operational module 506, community sharing operational module 508, process incentives operation module 510, that interact with profile data set 534, community data set 536, and incentive data set 538, respectively. Additionally, as is shown in FIG. 5, profile data set can comprise data representative of user demographic data 512, user medical history 514, user health goals 516, and user community preference (data sharing) settings 518. Community data set can comprise data representative of user demographic data 512, user medical history data 514, user health goals 516, and community interests (e.g., user interests in various community data offerings used to motivate the user to maintain one or more health management initiatives). Incentive data set can comprise data representative of applicable incentives 528, program goal tracking data 530, and incentive redemption setting data 532.

In an illustrative implementation, operational modules 506, 508, and 510 can comprise one or more portions of a health management web application (not shown) acting as exemplary health management platform 504. In the illustrative implementation, exemplary data sets 534, 536, and 538 can comprises one or more portions of one or more cooperating data stores.

In an illustrative operation, exemplary health management platform 504 can receive data requests and/or data inputs from various users 502 and process such user data input/data request using one or more operational modules 506, 508, 510 and interface with one or more data sets 534, 536, and 538 according to one or more health care portfolio management guidelines. Additionally, exemplary health management platform 504 can receive data from and communicate data to community 546 according to one or more settings found in one or more data sets 534, 536, and/or 538 according to one or more healthcare portfolio management guidelines. In an illustrative implementation, healthcare portfolio management guidelines 540 can comprise one or more rule based health management guidelines predicated on data representative of one or more program metrics of one or more program components of one or more incentive driven health management programs.

In an illustrative operation, one or more incentive driven health management engagement programs (e.g., utilizing one or more operational modules 506, 508, and 510 and respective data sets 534, 536, and 538) and associated community content (e.g., discussion threads, support content, based on user community preference and interests) can be communicated to one or more participating users by exemplary health management platform 504 as part of health management for the user and for the management of incentives and incentive redemption represented by incentive data 626.

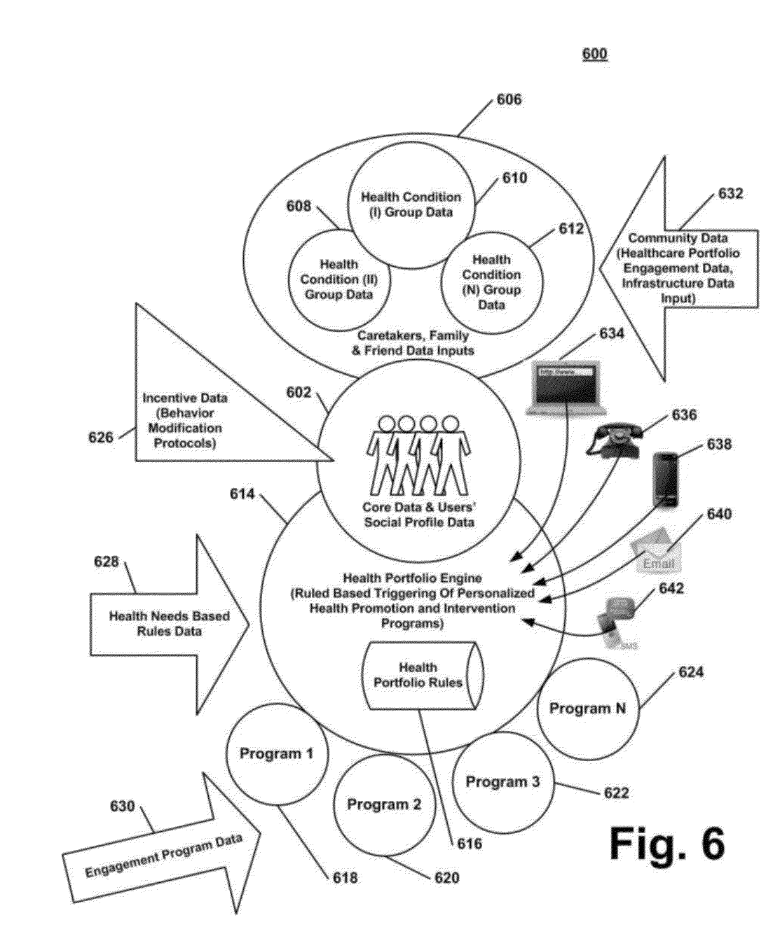

FIG. 6 shows exemplary interaction between various data of an exemplary health management environment 600. As is shown, exemplary health management environment 600 comprises core & users' social profile data set 602, caretakers/family/friends data inputs 606, healthcare portfolio engine (and healthcare portfolio engine data) 614, incentive data 626, health needs based rules data 628, engagement program data 630, health management programs (Program 1) 618, (Program 2) 620, (Program 3) 622, up to (Program N) 624, community data 632, and various data display/navigation/input devices including but not limited to computing environment 634, telephone 636, smart phone 638, e-mail devices 640, and short message devices 642.

Further, as is shown in FIG. 6, caretakers/family/friend data input 606 can comprise various health condition data: Health Condition (I) Group data 610, Health Condition (II) Group data 608, up to Health Condition (N) Group data 612. Also, health portfolio engine 614 can comprise healthcare portfolio rules 616.

In an illustrative operation, participating user's can interface with exemplary health management environment 600 as part of one or more health management initiatives. In the illustrative operation, participating users can be provided incentive data (e.g., behavior modification protocol data) 626 representative of one or more incentives that can be earned by meeting one or more program (618, 620, 622, and 624) requirements. The programs can be designed/created according to various engagement program data 630 and health needs based rules data 628 that can be tailored for one or more users according to user core data and users' social profile/communication data 602 (e.g., communication threads amongst and betwixt one or more participating users and other persons associated with the one or more participating users including but not limited to community members, third party healthcare providers, employers, the one or more users' healthcare service providers, and other associated persons). The programs can be administered by health portfolio engine (e.g., a rule based rigger of personalized health promotion and intervention programs predicated on health needs based ruled data 628) 614 according to health portfolio rules 616. As part of health management, users can also interface with caretakers/family/friends to share data regarding various health condition group data (e.g., diabetes, hypertension, obesity, etc.) 608, 610, and 612 as well as receive and communicate community data 632 with various community members and/or third party healthcare collaborators who are positioned to provide additional health services and/or provide additional health products to users as part of their program engagements. The data communication is facilitated in health management environment 600 through various data navigation/display/input devices 634, 636, 638, 640, and 642 that allows for the communication of various data including but not limited to core data & users' social profile data 602, caretakers/family/friend data input data 606, program data 618, 620, 622, and 64, community data 632, health needs based rules data, and incentive data 626 that can be administered by health portfolio engine 614 according to health portfolio rules 616. Accordingly, participating users can perform various health management activities according to the selected mobile enabled health management paradigm predicated on incentive driven social networking enabled health management program engagements.

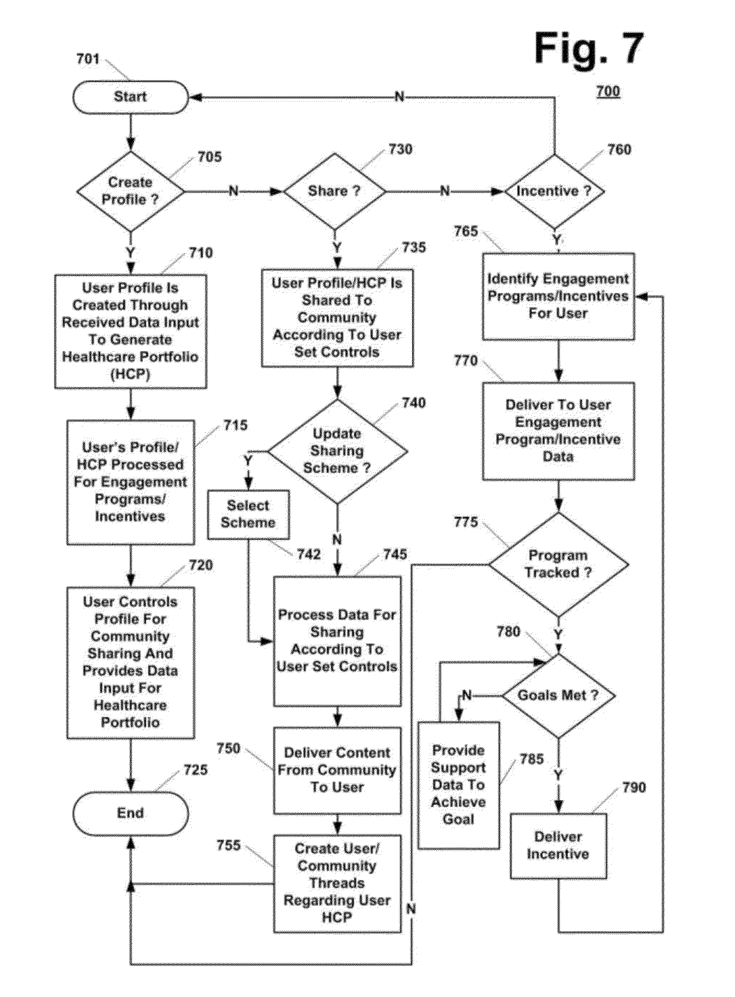

FIG. 7 shows exemplary method 700 describing illustrative processing performed in connection with processing data for use in managing, monitoring, recommending, and communicating health management data as part of an exemplary social networking based cyclical engagement incentive driven health management model. As is shown, processing begins at block 701 and proceeds to block 705 where data representative of a user profile is retrieved (e.g., by exemplary health management platform 420 of FIG. 4 from a cooperating data store) to determine if a user profile portion of a user's healthcare portfolio is to be created, updated, modified, and/or deleted. If the check at block 705 indicates that user profile data is to be processed, processing proceeds to block 710 where data representative of a user profile is received from one or more participating users (e.g., from users' 430 computing environment 425 to exemplary health management platform 420 over communications network 435) to generate and store data representative of a user healthcare portfolio (HCP).

In an illustrative implementation, a user healthcare portfolio can comprise various data comprising any of user profile data, user medical history data, one or more program metrics of one or more program components of one or more programs for a specific one or more user, user incentive data, user incentive redemption data, user health rating data, and other associated health management data specific to one or more of users. In the illustrative implementation, user profile data can comprise any of user personal information/data, user demographic data, user medical history data, user community sharing preferences, user incentive data, user incentive redemption data, user affinity data, user employment data, and other user data relevant for use to provide one or more features/operations by the herein described systems and methods.

From block 710, processing proceeds to block 715 where data can be received and associated (e.g., by exemplary health management application 420 of FIG. 4) with the user's profile data and/or HPC data regarding engagement programs and/or incentives that may be made available to the participating users for subsequent user (e.g., stored in a cooperating data store—405 and/or 415 of FIG. 4). Processing then proceeds to block 720 where data representative of the user's data sharing preference is associated with the user's profile. Additionally at block 720, additional user profile and/or user healthcare portfolio information may be received and processed (e.g., by exemplary health management platform 420). Processing then terminates at block 725.

If the check at block 705 indicates that that data regarding the user's profile and/or healthcare portfolio is not being received for processing, processing proceeds to block 730 where data representative of user shared data is retrieved (e.g., by health management platform 420 from one or more cooperating data stores—405 and/or 415 of FIG. 4) to determine if data is to be shared by one or more users with one or more community members and/or one or more third party healthcare collaborators. If the check at block 730 indicates that data is to be shared, processing proceeds to block 735 where the one or more portions of the user's profile data and/or the user's healthcare portfolio data is shared to one or more members of community (e.g., communicating data from one or more cooperating data stores cooperating with and from exemplary health management platform 420 over communications network 435 to community computing environment 440 for use by community members 445 and/or to healthcare collaborators computing environment 460 for use by one or more healthcare collaborators 465).

From block 735, processing proceeds to block 740 where a check is performed to determine the data sharing preferences for one or more participating users such that to retrieve data representative of a data sharing scheme (e.g., a participating user's preference to share data with others accessing the health management environment 400 of FIG. 4—community members, third party healthcare collaborators, etc.) to determine if a data sharing scheme for the one or more participating users has been defined. If the check at block 740 indicates that a data sharing scheme is to be updated, processing proceeds to block 742 where the user is prompted to select a data sharing scheme. From block 742, processing can proceed to block 745 and continue from there.

However, if the check performed at block 740 indicates that a data sharing scheme does not require updating, processing proceeds to block 745 where user profile data and/or user healthcare portfolio data is processed for sharing according to a user's set controls. Processing then proceeds to block 75 where data can be received by exemplary health management platform 420 from one or more community members 445 through community computing environment 440 through communications network 435 representative of various health management data for communication to the user regarding the user's health management. Processing then proceeds to block 755 where one or more community data conversation threads can be created by exemplary health management platform 420 comprising data representative of conversations between a user and one or more community members specific to one or more health management initiatives to which a user and/or community member may be undertaking Processing then terminates at block 725.

Further, as is shown in FIG. 7, if the check at block 730 indicates that the data is not to be shared, processing proceeds to block 760 where data representative of one or more incentives is retrieved (e.g., by exemplary health management platform 420 from one or more cooperating data stores—405 and/or 415 of FIG. 4) to determine which engagements to associated, modify, update, and/or delete for one or more participating users. If the check at block 760 indicates that there are no incentives to be associated, processing reverts to block 701 and proceeds from there.

However, if the check at block 760 indicates that incentive data (and associated program data relating to the incentive) is to be processed, processing proceeds to block 765 where data representative of one or more incentives and/or program engagements (e.g., one or more program metric of one or more program component of one or more programs) is retrieved (e.g., by exemplary health management platform 420 from one or more cooperating data stores—405 and/or 415 of FIG. 4). Processing then proceeds to block 770 where the processed incentive data and/or program engagement data is delivered (communicated) to the one or more participating users.

From block 770, processing proceeds to block 775 where data representative of compliance with one or more program metrics is received for processing to determine if compliance by one or more participating users is to be tracked. If the check at block 775 indicates that the program is not to be tracked, processing terminates at block 725. However, if the check at block 775 indicates that the program is to be tracked, processing proceeds to block 780 where data representative of compliance with one or more program metrics is received for processing to determine whether the participating user is being compliant with one or more program metrics of one or more program components of one or more programs of the one or more users' healthcare portfolio.

In an illustrative implementation, compliance data can be communicated by one or more participating users 430 utilizing user computing environment 425 over communications network 435 to health management platform 420 for processing and/or be communicated by one or third party healthcare collaborators 465 using healthcare collaborator computing environment 460 over communications network 435 to health management platform 420. In the illustrative implementation, the compliance data provided by third party healthcare collaborators and/or one or more parties associated with the user (e.g., community members, user healthcare provider, family member, friends, etc.) can comprise validated compliance data.

If the check at block 780 indicates that the one or more participating users have achieved the requirements of one or more program metrics, processing proceeds to block 790 where data representative of the associated incentive (e.g., an incentive associated with achieving one or more requirements of a program metric—for example earning $50 gift card to a sporting goods store for achieving weight loss of 15 pounds in three months as part of a program attending to preventing or treating hypertension) is delivered (communicated) to the one or more participating users. From block 790, processing reverts to block 765 and proceeds from there.

However, if the check at block 780 indicates that one or more program metrics have not been met, processing proceeds to block 780 where data representative of recommendations (e.g., support, guidance, hints, tricks, etc.) for achieving the program metric is communicated to the one or more participating users. From block 780, processing reverts to block 780 and proceeds from there.

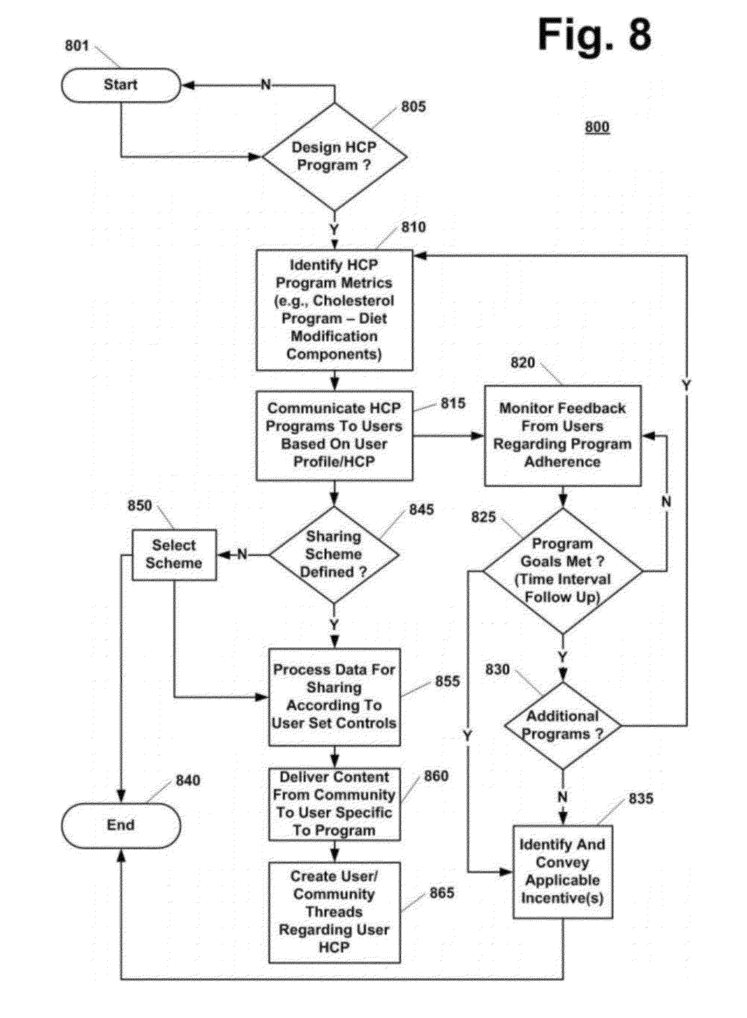

FIG. 8 shows exemplary method 800 describing illustrative processing performed in connection with the design and/or creation of one or more programs of an exemplary healthcare portfolio. As is shown, processing begins at block 801 and proceeds to block 805 where data is retrieved representative of one or more program components to determine if a healthcare portfolio program is to be designed. If the check is at block 805 indicates that no programs are to be designed and/or created, processing reverts to block 801 and proceeds from there.

However, if the check at block 805 indicates that a program is to be designed and/or created, processing proceeds to block 810 where data representative healthcare portfolio (HCP) program metrics (i.e., program component requirements/thresholds—e.g., for a cholesterol program, provide various weight management components) is stored to create one or more program metrics of one or more program components of one or more programs. In an illustrative implementation data representative of the programs can be retrieved from a cooperating data store cooperating with exemplary health management platform 420 of FIG. 4. In an illustrative implementation, one or more cooperating parties (e.g., employers, participating users, third party healthcare collaborators, etc.) can communicate data representative of one or more of program metrics, program components, and/or programs to exemplary health management platform 420. In the illustrative implementation, a computing application (not shown) offering one or more features for use in designing/creating a healthcare portfolio program can be utilized to input data representative of one or more program metrics, program components, and/or programs.

From block 810, processing proceeds to block 815 where the data representative of the created and/or designed programs is communicated to one or more users based on one or data components of one or more healthcare portfolios (e.g., user profiled data). From block 815 processing can proceed either to block 820 or block 845. At block 820, data representative of one or more users' adherence to one or more program metrics of one or more program components of a exemplary healthcare portfolio is processed and compared to stored data representative of one or more program requirements (e.g., one or more program metrics) to determine if the one or more participating users have satisfied one or more program metrics. In an illustrative implementation the program compliance data processed at block 820 can be inputted by one or more participating users 430 utilizing user computing environment 425 that can be communicated to exemplary health management platform 420. In an illustrative implementation, one or more third party healthcare collaborators and/or one or more parties associated with the user (e.g., community members, user healthcare provider, family member, friends, etc.) can submit validated user program compliance data representative of a user's compliance to one or more program metrics using healthcare collaborator computing environment 460 communicated to exemplary health management platform 420 over communications network 435.

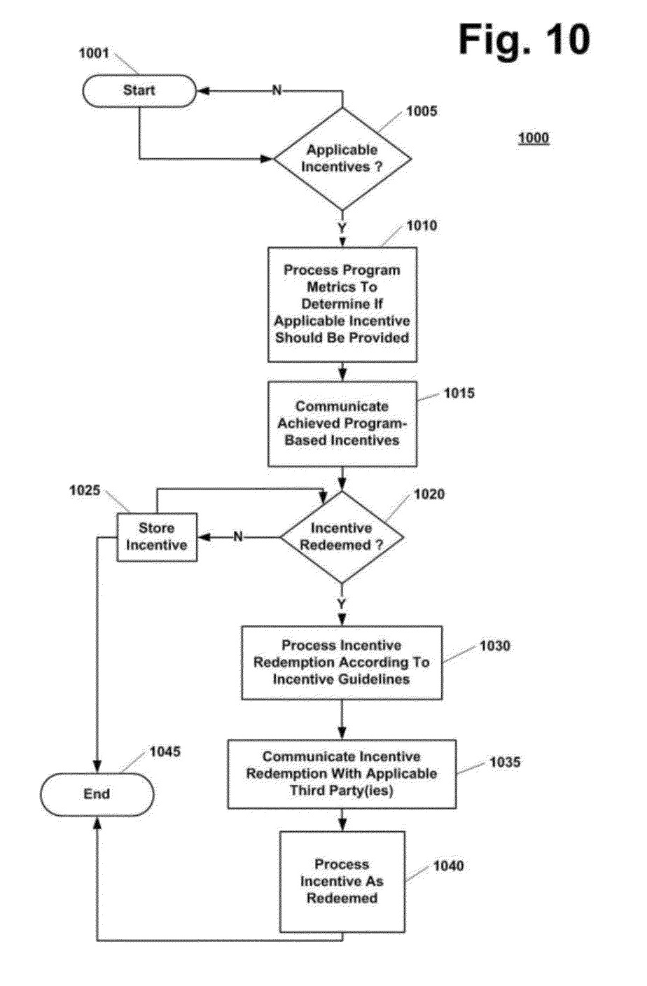

Processing from block 820 then proceeds to block 825 where a periodic check is performed to determine if applicable program metrics of one or more programs have been met. In an illustrative implementation, data representative of one or more program components and/or an entire program can be recommended/communicated to a user (e.g., lose 10 pounds as part of diabetes prevention program) by health management platform 420. The check at block 825 is a periodic check (e.g., part of a cyclical engagement model by health management platform 420 and users 430 to ensure continued and sustained compliance to one or more program metrics) such that if the user has accomplished the goal of losing 10 pounds, the health management platform will interface with the user on a selected periodic basis (e.g., every 6 months) to ensure that the user has kept off the 10 pounds (i.e., cyclical engagement—a program component that self repeats over a selected period of time). The periodic check acts to generate data for use in calculating a user's health rating as described in FIG. 10.

If the check at block 825 indicates that the program/program metrics have not been met or completed, processing reverts back to block 820 and proceeds from there. However, if the check at block 825 indicates that the program goals have been met, processing proceeds to block 830 to retrieve data from a cooperating data store by exemplary health management platform representative of one or more complimentary programs for the user (e.g., by meeting a diabetes prevention program goal of losing 10 pounds a complimentary program relating to undertaking health promoting activities of preventing hypertension can be recommended to the user). If the check at block 830 indicates that there are additional programs for communication/recommendation to a user, processing reverts back to block 810 and proceeds from there. However, if the check at block 830 indicates that here are no additional programs, processing proceeds to block 835 where data representative of one or more applicable incentives are communicated to the user (e.g., as is further described by FIG. 10). Processing then terminates at block 940. Furthermore if the check at block 825 indicates that the program goals have been met, processing can proceed to block 835 and proceed from there.

Also, from block 815, processing can proceed to block 845 where a check is performed to determine the data sharing preferences for one or more participating users such that to retrieve data representative of a data sharing scheme (e.g., a participating user's preference to share data with others accessing the health management environment 400 of FIG. 4—community members, third party healthcare collaborators, etc.) to determine if a data sharing scheme for the one or more participating users has been defined. If the check at block 845 indicates that a data sharing scheme has not been defined, processing proceeds to block 950 where the user is prompted to select a data sharing scheme. From block 850, processing can terminate at block 840. Also, from block 850, processing can proceed to block 855 and continue from there.

However, if the check performed at block 845 indicates that a data sharing scheme has been defined, processing proceeds to block 855 where data representative of the user's program metric compliance is processed according to a user's set controls. Processing then proceeds to block 860 where data can be received by exemplary health management platform 420 from one or more community members 445 through community computing environment 440 through communications network 435 representative of support content (e.g., to provide emotional and/or psychological support) for communication to the user regarding the user's compliance with one or more program metrics. Processing then proceeds to block 865 where one or more community data conversation threads can be created by exemplary health management platform 420 comprising data representative of conversations between a user and one or more community members specific to one or more healthcare portfolio health management programs to which a user and/or community member may be undertaking

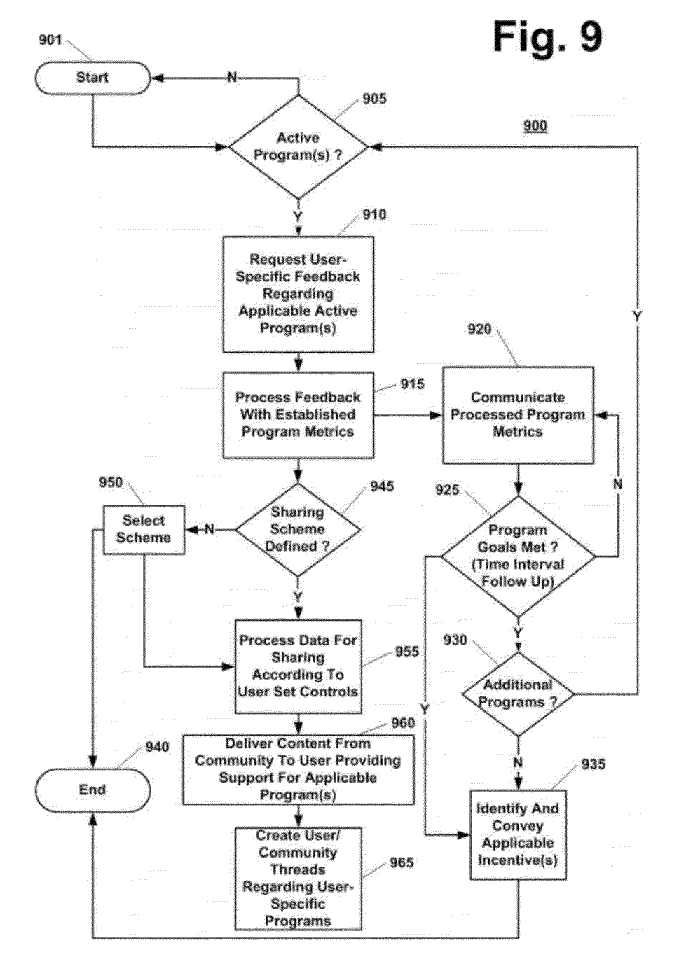

FIG. 9 shows exemplary method 900 describing illustrative processing performed in connection with the monitoring and storing compliance data associated with meeting/achieving one or more program metrics (e.g., program requirements) for one or more programs of a healthcare portfolio. As is shown, processing begins at block 901 and proceeds to block 905 where a data representative of one or more programs is retrieved (e.g., by exemplary health management platform 420 of FIG. 4) from a cooperating data store to determine if there are active programs for one or more participating users. If the check at block 905 indicates that there are no active programs for one or more participating users, processing reverts to block 901 and proceeds from there.

However, if the check at block 905 indicates that there are one or more active programs for one or more participating users, processing proceeds to block 910 where data representative of user compliance with one or more program metrics (e.g., program component requirements—e.g., lose 10 pounds as part of weight management program) of the one or more applicable active programs is requested to be inputted/communicated (e.g., by exemplary health management platform 420 of FIG. 4) by one or more participating users (e.g., 430 of FIG. 4)(i.e., communicated by one or more participating users 430 using user computing environment 425 to exemplary health management platform 420 over communications network 435 and/or by one or more healthcare collaborators 465 who can validate program metric compliance using healthcare collaborators computing environment 460 to exemplary health management platform 420 over communications network 435).

Processing then proceeds to block 915 where the received program metric compliance data is processed. From block 915 processing can proceed either to block 920 or block 945. At block 920, the processed program metrics are communicated to the one or more participating users. Processing from block 920 then proceeds to block 925 where a periodic check is performed to determine if applicable program metrics of one or more programs have been met. In an illustrative implementation, data representative of one or more program components and/or an entire program can be recommended/communicated to a user (e.g., lose 10 pounds as part of diabetes prevention program) by health management platform 420. The check at block 925 is a periodic check such that if the user has accomplished the goal of losing 10 pounds, the health management platform will interface with the user on a selected periodic basis (e.g., every 6 months) to ensure that the user has kept off the 10 pounds (i.e., cyclical engagement). The periodic check acts to generate data for use in calculating a user's health rating as described in FIG. 10.

If the check at block 925 indicates that the program/program metrics have not been met or completed, processing reverts back to block 920 and proceeds from there. However, if the check at block 925 indicates that the program goals have been met, processing proceeds to block 930 to retrieve data from a cooperating data store by exemplary health management platform representative of one or more complimentary programs for the user (e.g., by meeting a diabetes prevention program goal of losing 10 pounds a complimentary program relating to undertaking health promoting activities of preventing hypertension can be recommended to the user). If the check at block 930 indicates that there are additional programs for communication/recommendation to a user, processing reverts back to block 905 and proceeds from there. However, if the check at block 930 indicates that here are no additional programs, processing proceeds to block 935 where data representative of one or more applicable incentives are communicated to the user (e.g., as is further described by FIG. 10). Processing then terminates at block 940. Furthermore if the check at block 925 indicates that the program goals have been met, processing can proceed to block 935 and proceeds from there.

Also, from block 915, processing can proceed to block 945 where a check is performed to determine the data sharing preferences for one or more participating users such that to retrieve data representative of a data sharing scheme (e.g., a participating user's preference to share data with others accessing the health management environment 400 of FIG. 4—community members, third party healthcare collaborators, etc.) to determine if a data sharing scheme for the one or more participating users has been defined. If the check at block 945 indicates that a data sharing scheme has not been defined, processing proceeds to block 950 where the user is prompted to select a data sharing scheme. From block 950, processing can terminate at block 940. Also, from block 950, processing can proceed to block 955 and continue from there.

However, if the check performed at block 945 indicates that a data sharing scheme has been defined, processing proceeds to block 955 where data representative of the user's program metric compliance is processed according to a user's set controls. Processing then proceeds to block 960 where data can be received by exemplary health management platform 420 from one or more community members 445 through community computing environment 440 through communications network 435 representative of support content (e.g., to provide emotional and/or psychological support) for communication to the user regarding the user's compliance with one or more program metrics. Processing then proceeds to block 965 where one or more community data conversation threads can be created by exemplary health management platform 420 comprising data representative of conversations between a user and one or more community members specific to one or more healthcare portfolio health management programs to which a user and/or community member may be undertaking

FIG. 10 shows exemplary method 1000 describing illustrative processing performed in connection with the awarding and redemption of one or more incentives associated with the completion of one or more program metrics of a one or more healthcare portfolio programs (e.g., processing of data representative of one or more incentives by exemplary health management platform 420 of FIG. 4). As is shown, processing begins at block 1001 and proceeds to block 1005 where data representative of incentives (i.e., incentives available for a given user) is retrieved from a cooperating data store to determine if there are one or more incentives that are available for one or more participating users. In an illustrative implementation, an incentive can comprise any of an award including but not limited to merchandise, cash, invoice credits (e.g., for healthcare services), and internal system credits to the health management system that can be redeemed from one or more community members, third party healthcare collaborators, sponsors, and/or the operator of health management platform (e.g., that can provide additional features/operations of the health management platform to participating users). If the check at block 1005 indicates that there no available incentives, processing reverts to block 1001 and proceeds from there.

However, if the check at block 1005 indicates that there are available incentives, processing proceeds to block 1010 where data representative of one or more program metrics is retrieved (e.g. by exemplary health management platform 420 of FIG. 4) from a cooperating data store to determine if an applicable incentive should be communicated to one or more participating users. In an illustrative implementation, program metric data can comprise data representative of one or more requirements that are required to be met for one or more program components of a healthcare portfolio (e.g., quitting smoking for three months). Processing then proceeds to block 1015 where data representative of achieved program-based incentives are communicated to one or more participating users.

In an illustrative implementation, one or more participating users and/or third party program metric observers can communicate data to exemplary health management platform 420 of FIG. 420 representative of compliance with one or more program metrics for one or more program components for processing by the exemplary health management platform 420 and compared by the exemplary health management platform 420 to program metrics data retrieved from one or more cooperating data stores to determine if the one or more participating users have met all of the requirements for one or more program metrics—i.e., whether the user has achieved a program incentive.

From block 1015, processing proceeds to block 1020 where data representative of one or more redeemed incentives is retrieved from a cooperating data store to determine if a communicated achieved program-based incentive has been redeemed by one or more participating users. If the check at block 1020 indicates that an incentive has not been redeemed, processing proceed to block 1025 where data is generated, associated with, and stored for communicated incentive to categorize the incentive as being not redeemed. Processing then reverts back to block 1020 and proceeds from there.

However, if the check at block 1020 indicates that communicated incentive is to be redeemed, processing proceeds to block 1030 where data representative of the incentive redemption received and processed by exemplary health management platform 420 in accordance with one or more retrieved incentive redemption guidelines retrieved from a cooperating data store. Processing then proceeds to block 1035 where data representative of the redeemed incentive is communicated with applicable third parties (e.g., incentive sponsors, incentive product/service providers, employers, community members, and other persons identified by the participating user to whom incentive redemption data is to be communicated). From block 1035, processing proceeds to block 1040 where data is generated and stored representative of a redeemed incentive. Processing then terminates at block 1045.

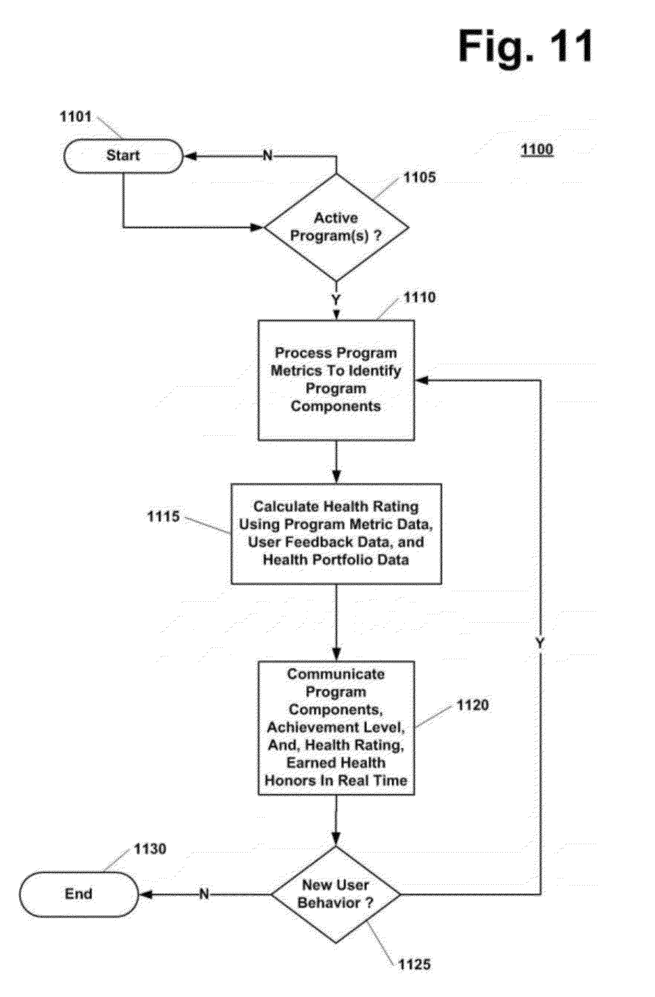

FIG. 11 shows exemplary method 1100 describing illustrative processing performed in connection with generating a health report comprising various data components including but not limited to a health rating data, health score data, health medal(s) data, health program component data, incentive data, community data, user data, and/or health management data. As is shown, processing begins at block 1101 and proceeds to block 1105 where data is retrieved from a cooperating data store representative of one or more programs (e.g., one or more health programs that can comprise one or more portions of healthcare portfolio data) to determine if there are one or more active programs. If the check at block 1105 indicates that there are no active programs, processing reverts to block 1101 and proceeds from there.

However, if the check at block 1105 indicates that there active programs, processing proceeds to block 1110 where data representative of the identified active program metrics is retrieved from a cooperating data store and processed to determine the program components of the identified active program. Processing then proceeds to block 1115 where data representative of a health rating is generated (e.g., generated/calculated by, in an illustrative implementation, health management platform 420 of FIG. 4). In an illustrative implementation, the health rating can comprise a portion of a health report comprising a health score and health medals (e.g., health awards). In the illustrative implementation, a health medal can include but is not limited to data representative of the achievement of one or more requirements of one or more health program components (e.g., quitting smoking for 3 months) that is communicated to a participating user as a selected graphic (e.g., illustratively, a health medal, card, or badge) that comprises a portion of the exemplary health report. In the illustrative implementation, the health medal can comprise data representative of an embedded incentive driven program component and upon completion of one or more program metrics for the one or more program components a health score can be calculated. In the illustrative implementation and in illustrative operation, the health score and health medals portion of the health rating can be calculated by processing various data including but not limited to the exemplary program metric data (e.g., program component requirements), user feedback data (e.g., compliance data provided by the user and/or third party observers regarding the compliance of a user to a program component and/or to validate the achievement of one or more program component program metrics), and health portfolio data (e.g., user profile data, user medical history, recommended programs/program component data). In an illustrative implementation, the health score can be calculated using compliance or partial compliance to one or more program metrics of one or more programs. In the illustrative implementation, the incentives described in FIG. 10 can be awarded for achieving a pre-defined health score.

In an illustrative implementation, the health rating can further comprise actuarial data that can be calculated (e.g., calculated by exemplary health management platform 420 of FIG. 4) using the herein described data of the risk associated in a user needing to exhaust one or more benefits of a selected health benefit plan (e.g., the risk can be calculated according to a selected actuarial algorithm that accepts various data inputs including but not limited to data representative of exemplary program metric data (e.g., program component requirements), user feedback data (e.g., compliance data provided by the user and/or third party observers regarding the compliance of a user to a program component and/or to validate the achievement of one or more program component program metrics), and health portfolio data (e.g., user profile data, user medical history, recommended programs/program component data)).

From block 1115, processing proceeds to block 1120 where the data representative of one or more portions of the calculated health rating, program components, achievement level (e.g., health score), and earned health honors (e.g., health medals) can be communicated to participating users in real time as one or more portions of an exemplary health report. Processing then proceeds to block 1125 where data representative of user's health management behavior (e.g., over a period of time) is retrieved from a cooperating data store and processed to determine if a participating user has undergone any changes in their health management behavior (e.g., a smoker who quit returns back to smoking) and to determine if the a new health rating should be calculated. If the check at block 1125 indicates that there is a change to the user's health management behavior, processing reverts to block 1110 which will trigger the recalculation of the user's health rating and other associated health report data as processing proceeds from block 1110.

However, if the check at block 1125 indicates that there isn't a change to the user's health management behavior, processing proceeds to block 1130 and ends. In an illustrative implementation, a user may be required to communicate data inputs (e.g., to an exemplary health management platform 420 of FIG. 4) of the user's health management behavior over a selected period of time (e.g., every month) or may receive data from a third party observing/validating the health management behavior of a user.

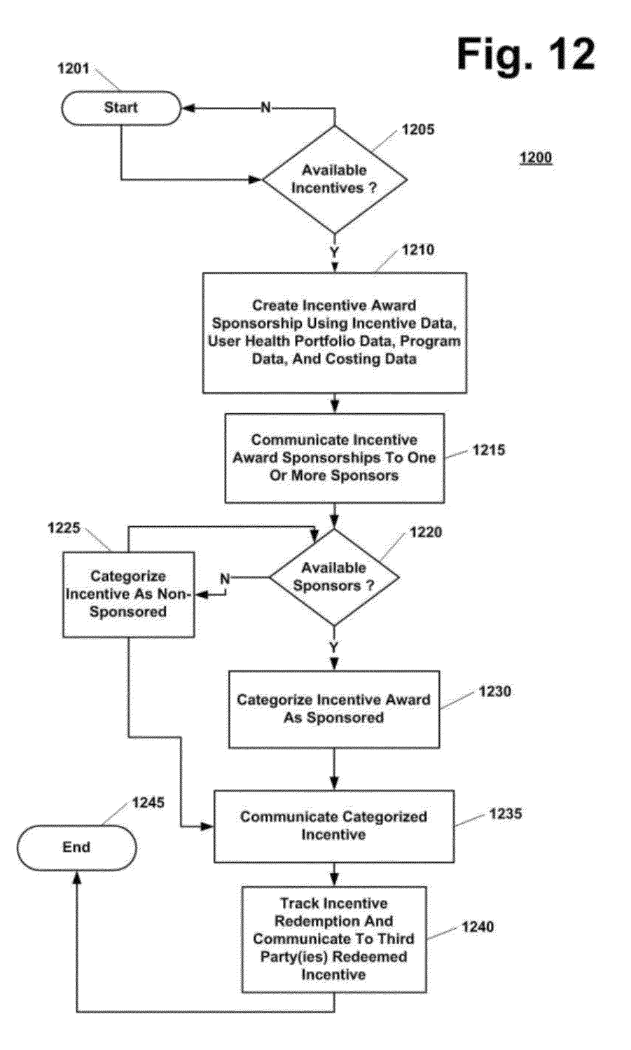

FIG. 12 shows exemplary method 1200 describing illustrative processing performed in connection with generating and communicating one or more sponsored incentives. As is shown, processing begins at block 1201 and proceeds to block 1205 where a check is performed (e.g., generating and/or retrieving data from one or more cooperating data stores representative of one or more available incentives) to determine whether there are one or more available incentives that are available for a sponsorship opportunity. If the check at block 1205 indicates that there are no available incentives, processing reverts back to block 1201 and proceeds from there.

However, if the check at block 1205 indicates that there are one or more available incentives, processing proceeds to block 1210 where data representative of an incentive award sponsorship opportunity is stored in a cooperating data store. In an illustrative operation, the created award sponsorship opportunity data is created using data comprising any of incentive data, health portfolio data, health program data, and costing data (e.g., data representative of the cost to a sponsor to purchase the one or more incentive sponsorship opportunity). Processing then proceeds to block 1215 where data representative of the incentive sponsorship opportunities is communicated to one or more sponsors (i.e., sponsors who are seeking to sponsor an incentive). A check is then performed at block 1220 to determine (e.g., by retrieving data from a cooperating data store representative of one or more interested sponsors that can be communicated from one or more interested sponsors to an exemplary health management platform—e.g., 420 of FIG. 4) if there are available sponsors who are interested in purchasing one or more incentive sponsorship opportunities. In an illustrative implementation, a sponsor can comprise any parties including but not limited to an employer, health plan, and/or advertiser. If the check at block 1220 indicates that there are no available (e.g., interested) sponsors to purchase the one or more created incentive award sponsorship opportunities, processing proceeds to block 1225 where data is associated with the created incentive sponsorship opportunity and stored in an cooperating data store to categorize the available incentive as a non-sponsored incentive. From there, processing can revert to block 1220 and proceed from there or proceed to block 1235 and proceed from there.

However, if the check at block 1220 indicates that there are available sponsors, processing then proceeds to block 1230 where data is associated with the data representative of the incentive award sponsorship to indicate one or more sponsors are available to purchase an incentive award sponsorship opportunity to categorize the incentive award as a sponsored incentive award. Processing then proceeds to block 1235 where data representative of the categorized incentive is communicated to one or more participating parties comprising the owner of the incentive, the party to whom the incentive was created (e.g., users 430 of FIG. 4), and other associated third party collaborators. Processing then proceeds to block 1240 where data representative of the redemption of a communicated incentive is processed and stored in a cooperating data store to associate a redemption indicator with data representative of the communicated incentive. Additionally, at block 1240 data representative of a redeemed incentive can be communicated to one or more third parties who can, in an illustrative implementation, participate in delivering one or more products, services, and/or product components, and service components that comprise a redeemed incentive. Processing then ends at block 1245.

It is understood that the herein described systems and methods are susceptible to various modifications and alternative constructions. There is no intention to limit the herein described systems and methods to the specific constructions described herein. On the contrary, the herein described systems and methods are intended to cover all modifications, alternative constructions, and equivalents falling within the scope and spirit of the herein described systems and methods.

It should also be noted that the herein described systems and methods can be implemented in a variety of electronic environments (including both non-wireless and wireless computer environments, including cell phones and video phones), partial computing environments, and real world environments. The various techniques described herein may be implemented in hardware or software, or a combination of both. Preferably, the techniques are implemented in computing environments maintaining programmable computers that include a computer network, processor, servers, a storage medium readable by the processor (including volatile and non-volatile memory and/or storage elements), at least one input device, and at least one output device. Computing hardware logic cooperating with various instructions sets are applied to data to perform the functions described above and to generate output information. The output information is applied to one or more output devices. Programs used by the exemplary computing hardware may be preferably implemented in various programming languages, including high level procedural or object oriented programming language to communicate with a computer system. Illustratively the herein described apparatus and methods may be implemented in assembly or machine language, if desired. In any case, the language may be a compiled or interpreted language. Each such computer program is preferably stored on a storage medium or device (e.g., ROM or magnetic disk) that is readable by a general or special purpose programmable computer for configuring and operating the computer when the storage medium or device is read by the computer to perform the procedures described above. The apparatus may also be considered to be implemented as a computer-readable storage medium, configured with a computer program, where the storage medium so configured causes a computer to operate in a specific and predefined manner.

Although exemplary implementations of the herein described systems and methods have been described in detail above, those skilled in the art will readily appreciate that many additional modifications are possible in the exemplary embodiments without materially departing from the novel teachings and advantages of the herein described systems and methods. Accordingly, these and all such modifications are intended to be included within the scope of the herein described systems and methods. The herein described systems and methods may be better defined by the following exemplary claims.

What is claimed is:

1. A system for managing healthcare information for use to manage a user's health, comprising:
a computing processor; and
computing memory communicatively coupled with the computing processor, the computing memory having stored therein instructions that, if executed by the computing processor, cause the computing processor to perform operations comprising:
receiving data representative of a user, the received user data comprising one or more of user demographic data, user health data, and user community preference data ;
generating a healthcare portfolio for the user, the healthcare portfolio comprising one or more of healthcare programs comprising data representative of one or more recommended health promoting activities specific to the user;
communicating data representative of one or more incentives to the user, the incentives being awarded to the user by one or more collaborating third parties for compliance to one or more of the health promoting activities of the one or more healthcare programs;
receiving data from one or more participating parties representative of compliance with the one or more health promoting activities;
processing the received user compliance data to calculate a health rating and/or health score;
processing the calculated health score to determine whether to communicate to the user data representative of one or more awarded incentives;
communicating data based on the user's community preference data from one or more parties of a user community to the user data representative of information regarding one or more of the user's health data, the user's compliance data, and the user's healthcare portfolio; and
receiving for communication based on the user's community preference to the one or more collaborating parties of the user community data representative of information regarding one or more of the user's health data, the user's compliance data, and the user's healthcare portfolio.

2. A system for managing healthcare information for use to manage a user's health, comprising:
a computing processor; and
computing memory communicatively coupled with the computing processor, the computing memory having stored therein instructions that, if executed by the computing processor, cause the computing processor to perform operations comprising:
receiving data representative of a user, the received user data comprising one or more of user demographic data, user health data, and user community preference data ;
generating a healthcare portfolio for the user, the healthcare portfolio comprising one or more of healthcare programs comprising data representative of one or more recommended health promoting activities specific to the user;
communicating data representative of one or more incentives to the user, the incentives being awarded to the user by one or more collaborating third parties for compliance to one or more of the health promoting activities of the one or more healthcare programs;
receiving data from one or more participating parties representative of compliance with the one or more health promoting activities; and
generating data representative of a health rating for the user, the health rating being calculated using data representative a health score associated with the user based on completed health-promoting activities completed by the user.

3. The system recited in claim 2, further comprising generating data representative of a selected health promoting game.

4. The system as recited in claim 3, further comprising generating data representative of one or more rules for the selected health promoting game.

5. The system as recited in claim 4, further comprises generating data representative of one or more game components comprising data representative of one or more challenges of the selected health promoting game.

6. The system as recited in claim 5, wherein the one or more game components comprise data representative of one or more states of the selected health promoting game.

7. The system as recited in claim 6, further comprising receiving data representative of the user's adherence to the one or more challenges of the one or more game components to generate a health data matrix for the user.

8. The system as recited in claim 7, further comprising generating the health score using the user adherence data.

9. The system as recited in claim 8, further comprising generating the health score using received data from the user representative of the user's activity as proscribed by the one or more game components and associating the one or more incentives for award to the user based on the completed one or more challenges.

10. The system as recited in claim 9, further comprising generating a health report comprising data representative of aggregated interactions by the user with the one or more game components.

11. The system as recited in claim 10, wherein the health report comprises data representative of one or more awarded incentives.

12. The system as recited in claim 9, wherein the health report comprises one or more health related engagements that the user can perform.

13. The system as recited in claim 12, wherein the one or more health engagements comprise one or more selected health promoting steps.

14. The system as recited in claim 13, wherein the components of the one or more health engagements are based on the outcome of one or more other health engagements.

15. The system as recited in claim 13, wherein data representative of an earned reward is communicated to a user who completes one or more of the selected health promoting steps of the one or more health engagements.

16. The claim as recited in claim 12, wherein the one or more health engagements comprise a cyclic health engagement and a dispersed health engagement.

17. The claim as recited in claim 16, wherein the one or more health engagements have a selected period of time for completion by a user.

18. The system as recited in claim 12, wherein the generated health score is based on the participation in the one or more health engagements by a user.

19. The system as recited in claim 18, further comprising data representative of the user's individualized health statistics as a function of participating in the one or more health engagements.

20. The system as recited in claim 19, further comprising generating data of other one or more health engagements based on the generated user's individualized health statistics.
